(19) United States
(12) Patent Application Publication
(10) Pub. No.: US 2026/0364620 A1
(43) Pub. Date: Nov. 19, 2026

(54) UNIT FOR UPRIGHT AND INVERTED ATTITUDES

(71) Applicant: YOSHNO KOGYOSHO CO., LTD., Tokyo (JP)

(72) Inventors: Kotaro FUJIWARA, Tokyo (JP); Shinya MAEDA, Tokyo (JP)

(73) Assignee: YOSHNO KOGYOSHO CO., LTD., Tokyo (JP)

(21) Appl. No.: 19/133,552

(22) PCT Filed: Nov. 30, 2023
(86) PCT No.: PCT/JP2023/042842

§ 371 Date: May 28, 2025

(30) Foreign Application Priority Data
Nov. 30, 2022 (JP) 2022-191685
Mar. 23, 2023 (JP) 2023-047074

(51) Int. Cl. B05B 11/00; B05B 11/10

(52) U.S. Cl. CPC B05B 11/0059; B05B 11/0008; B05B 11/0067; B05B 11/1009; B05B 11/1067

(57) ABSTRACT

A unit for upright and inverted attitudes includes an upright-attitude inlet, an inverted-attitude inlet, a relay port, a first switching valve, a second switching valve, and at least one of a first prevention part and a second prevention part, the first prevention part being configured to prevent a second switching valve from entering a first path through which a content liquid is directed toward the relay port from the upright-attitude inlet during an upright attitude of a discharge device, and the second prevention part being configured to prevent a first switching valve from entering a second path through which a content liquid is directed toward the relay port from the inverted-attitude inlet during an inverted attitude of the discharge device.

### TECHNICAL FIELD

The present invention relates to a unit for upright and inverted attitudes.

Priority is claimed on Japanese Patent Application No. 2022-191685, filed Nov. 30, 2022, and Japanese Patent Application No. 2023-047074, filed Mar. 23, 2023, the contents of which are incorporated herein by reference.

### BACKGROUND ART

As a unit for upright and inverted attitudes attached to a cylinder part of a discharge device, there is known a configuration including an upright-attitude inlet having a content liquid inlet of a cylinder part into which a content liquid in a container main body can be introduced during the upright attitude of the discharge device, an inverted-attitude inlet having a content liquid inlet into which a content liquid in the container main body can be introduced during the inverted attitude of the discharge device, a relay port able to communicate with the content liquid inlet, the upright-attitude inlet, and the inverted-attitude inlet, a first switching valve abutting an upright-attitude valve seat and configured to cut off communication between the inverted-attitude inlet and the relay port during the upright attitude of the discharge device, and a second switching valve abutting an inverted-attitude valve seat and configured to cut off communication between the upright-attitude inlet and the relay port during the inverted attitude of the discharge device.

In the unit for upright and inverted attitudes, the inside of the container main body and the content liquid inlet of the cylinder part are communicating with respect to each other through the upright-attitude inlet and the relay port during the upright attitude of the discharge device, and the inside of the container main body and the content liquid inlet are communicating with respect to each other through the inverted-attitude inlet and the relay port during the inverted attitude of the discharge device.

### CITATION LIST

### Patent Document

Patent Document 1: Japanese Unexamined Patent Application, First Publication No. 2017-47355

### SUMMARY OF INVENTION

### Technical Problem

In the unit for upright and inverted attitudes, when the content liquid in the container main body is introduced into the content liquid inlet of the cylinder part during the upright attitude of the discharge device, the second switching valve approaches the inverted-attitude valve seat on the liquid flow of the content liquid, and decompression in the cylinder part is exerted on the second switching valve through the relay port. Accordingly, the second switching valve may be pressed against the inverted-attitude valve seat.

Meanwhile, when the content liquid in the container main body is introduced into the content liquid inlet during the inverted attitude of the discharge device, the first switching valve approaches the upright-attitude valve seat on the liquid flow of the content liquid, and the decompression in the cylinder part is exerted on the first switching valve through the relay port. Accordingly, the first switching valve may be pressed against the upright-attitude valve seat.

For these reasons, it may not be possible to smoothly introduce the content liquid in the container main body into the cylinder part.

The present invention is directed to providing a unit for upright and inverted attitudes capable of smoothly introducing a content liquid in a container main body into a cylinder part.

### Solution to Problem

A first aspect of the present invention is a unit for upright and inverted attitudes attached to a cylinder part of a discharge device, the unit for upright and inverted attitudes including: an upright-attitude inlet into which a content liquid in a container main body is able to be introduced into a content liquid inlet of the cylinder part during an upright attitude of the discharge device; an inverted-attitude inlet into which the content liquid in the container main body is able to be introduced into the content liquid inlet during an inverted attitude of the discharge device; a relay port that is able to communicate with the content liquid inlet, the upright-attitude inlet, and the inverted-attitude inlet; a first switching valve abutting an upright-attitude valve seat and configured to cut off communication between the inverted-attitude inlet and the relay port during the upright attitude of the discharge device; a second switching valve abutting an inverted-attitude valve seat and configured to cut off communication between the upright-attitude inlet and the relay port during the inverted attitude of the discharge device; and at least one prevention part of a first prevention part and a second prevention part, the first prevention part being configured to prevent the second switching valve from entering a first path through which the content liquid is directed toward the relay port from the upright-attitude inlet during the upright attitude of the discharge device, and the second prevention part being configured to prevent the first switching valve from entering a second path through which the content liquid is directed toward the relay port from the inverted-attitude inlet during the inverted attitude of the discharge device.

In this case, the unit for upright and inverted attitudes includes at least one of the first prevention part and the second prevention part, the first prevention part being configured to prevent the second switching valve from entering the first path through which the content liquid is directed toward the relay port from the upright-attitude inlet during the upright attitude of the discharge device, and the second prevention part being configured to prevent the first switching valve from entering the second path through which the content liquid is directed toward the relay port from the inverted-attitude inlet during the inverted attitude of the discharge device. Accordingly, when the content liquid in the container main body is introduced into the content liquid inlet of the cylinder part, it is possible to do at least one of the preventing the content liquid flowing through the first path from coming into contact with the second switching valve, the second switching valve from riding the liquid flow of the content liquid and approaching the inverted-attitude valve seat, during the upright attitude of the discharge device, and the preventing the content liquid flowing through the second path from coming into contact with the first switching valve, the first switching valve from riding the liquid flow of the content liquid and approaching the upright-attitude valve seat, during the inverted attitude of the discharge device.

Accordingly, when the content liquid is introduced into the content liquid inlet of the cylinder part, it is possible to do at least one of the preventing the second switching valve from being pressed against the inverted-attitude valve seat due to decompression in the cylinder part exerted through the relay port during the upright attitude of the discharge device and the preventing the first switching valve from being pressed against the upright-attitude valve seat due to decompression in the cylinder part exerted through the relay port during the inverted attitude of the discharge device, and it is possible to smoothly introduce the content liquid in the container main body into the cylinder part.

According to a second aspect of the present invention, the unit for upright and inverted attitudes of the first aspect further includes an outer tube member fitted onto the cylinder part and having a lower end opening that becomes the upright-attitude inlet, wherein a topped tubular covering portion protruding upward and configured to cover the upright-attitude inlet from above is formed on an opening circumferential edge portion of the upright-attitude inlet in an inner surface of the outer tube member, a side opening that opens in a radial direction and configured to communicate with the upright-attitude inlet and an inside of the outer tube member is formed in a circumferential wall of the covering portion, and the first prevention part configured to prevent the second switching valve from entering the first path during the upright attitude of the discharge device protrudes upward from a top wall of the covering portion.

In this case, the side opening configured to communicate with the upright-attitude inlet and the inside of the outer tube member is formed in the circumferential wall of the covering portion, and the first prevention part protrudes upward from the top wall of the covering portion. The second switching valve is located in a space surrounded by the first prevention part, the upper surface of the top wall of the covering portion and the inner circumferential surface of the outer tube member during the upright attitude of the discharge device. Accordingly, it is possible to reliably prevent the second switching valve from entering the first path.

According to a third aspect of the present invention, in the unit for upright and inverted attitudes of the second aspect, the first prevention part is formed in a plate shape with a front surface that opens on a side in a radial direction where the side opening is open when seen in an upward/downward direction, a space between a portion of an inner circumferential surface of the outer tube member facing the side opening and a front surface of the first prevention part in the radial direction and the side opening and the front surface of the first prevention part becomes an inlet portion of the first path, and a guide portion configured to guide the second switching valve attempting to enter the inlet portion toward a back surface of the first prevention part during the upright attitude of the discharge device is provided inside the outer tube member.

In this case, the guide portion configured to guide the second switching valve attempting to enter the inlet portion of the first path toward the back surface of the first prevention part during the upright attitude of the discharge device is provided inside the outer tube member. Accordingly, it is possible to reliably prevent the second switching valve from entering the first path.

According to a fourth aspect of the present invention, the unit for upright and inverted attitudes according to any one of the first to third aspects further includes at least one escape recess of a first escape recess and a second escape recess, the first escape recess being configured to allow the second switching valve to enter therein and separate the second switching valve from the first path on a side opposite to the inverted-attitude valve seat and in a direction crossing an opening direction of the upright-attitude inlet during the upright attitude of the discharge device, and the second escape recess being configured to allow the first switching valve to enter therein and separate the first switching valve from the second path on a side opposite to the upright-attitude valve seat and in a direction crossing an opening direction of the inverted-attitude inlet during the inverted attitude of the discharge device.

The unit for upright and inverted attitudes includes at least one of the first escape recess and the second escape recess, the first escape recess being configured to allow the second switching valve to enter therein and separate the second switching valve from the first path on the side opposite to the inverted-attitude valve seat and in the direction crossing the opening direction of the upright-attitude inlet during the upright attitude of the discharge device, and the second escape recess being configured to allow the first switching valve to enter therein and separate the first switching valve from the second path on the side opposite to the upright-attitude valve seat and in the direction crossing an opening direction of the inverted-attitude inlet during the inverted attitude of the discharge device. Accordingly, when the content liquid in the container main body is introduced into the content liquid inlet, it is possible to do at least one of the preventing the content liquid flowing through the first path from coming into contact with the second switching valve, the second switching valve from riding the liquid flow of the content liquid and approaching the inverted-attitude valve seat, during the upright attitude of the discharge device, and the preventing the content liquid flowing through the second path from coming into contact with the first switching valve, the first switching valve from riding the liquid flow of the content liquid and approaching the upright-attitude valve seat, during the inverted attitude of the discharge device.

Accordingly, when the content liquid is introduced into the content liquid inlet, it is possible to do at least one of the preventing the second switching valve from being pressed against the inverted-attitude valve seat due to decompression in the cylinder part exerted through the relay port during the upright attitude of the discharge device, and the preventing the first switching valve from being pressed against the upright-attitude valve seat due to decompression in the cylinder part exerted through the relay port during the inverted attitude of the discharge device, and it is possible to smoothly introduce the content liquid in the container main body into the cylinder part.

According to a fifth aspect of the present invention, in the unit for upright and inverted attitudes of the first aspect, the upright-attitude valve seat is directed upward, the inverted-attitude valve seat is directed downward, the at least one prevention part is formed in a tubular shape extending in the upward/downward direction and faces at least one valve seat of the upright-attitude valve seat and the inverted-attitude valve seat in the upward/downward direction, and at least one switching valve of the first switching valve and the second switching valve enters an inside of the at least one prevention part and is accommodated therein when the at least one switching valve is separated from the at least one valve seat in the upward/downward direction.

In this case, when the at least one of the first switching valve and the second switching valve is separated from the valve seat in the upward/downward direction, the switching valve enters the inside of the at least one prevention part and is accommodated therein. Accordingly, when the content liquid in the container main body is introduced into the content liquid inlet of the cylinder part, it is possible to reliably do at least one of the preventing the content liquid flowing through the first path from coming into contact with the second switching valve, the second switching valve from riding the liquid flow of the content liquid and approaching the inverted-attitude valve seat, during the upright attitude of the discharge device, and the preventing the content liquid flowing through the second path from coming into contact with the first switching valve, the first switching valve from riding the liquid flow of the content liquid and approaching the upright-attitude valve seat, during the inverted attitude of the discharge device.

According to a sixth aspect of the present invention, in the unit for upright and inverted attitudes of the fifth aspect, the at least one prevention part is the second prevention part and the first prevention part, the second prevention part is provided at a position facing the upright-attitude valve seat in the upward/downward direction and where the first switching valve enters thereinto and is accommodated therein during the inverted attitude of the discharge device, and the first prevention part is provided at a position facing the inverted-attitude valve seat in the upward/downward direction and where the second switching valve enters thereinto and is accommodated therein during the upright attitude of the discharge device.

In this case, the at least one prevention part is the second prevention part or the first prevention part, the second prevention part is provided at a position facing the upright-attitude valve seat in the upward/downward direction and where the first switching valve enters thereinto and is accommodated therein during the inverted attitude of the discharge device, and the first prevention part is provided at a position facing the inverted-attitude valve seat in the upward/downward direction and where the second switching valve enters thereinto and is accommodated therein during the upright attitude of the discharge device. Accordingly, when the content liquid in the container main body is introduced into the content liquid inlet of the cylinder part, it is possible to reliably prevent both the content liquid flowing through the first path from coming into contact with the second switching valve and the second switching valve from riding the liquid flow of the content liquid and approaching the inverted-attitude valve seat during the upright attitude of the discharge device, and the content liquid flowing through the second path from coming into contact with the first switching valve and the first switching valve from riding the liquid flow of the content liquid and approaching the upright-attitude valve seat during the inverted attitude of the discharge device.

Since the prevention part is provided at both of the above-mentioned positions, the two parts provided at each of the above-mentioned positions and equipped with the prevention part can easily be made to have the same shape and size.

### Advantageous Effects of Invention

According to the present invention, it is possible to smoothly introduce a content liquid in a container main body into a cylinder part.

### BRIEF DESCRIPTION OF DRAWINGS

FIG. 1 A longitudinal cross-sectional view of a discharge device having a unit for upright and inverted attitudes shown as a first embodiment according to the present invention.

FIG. 2 An enlarged view of the unit for upright and inverted attitudes in FIG. 1.

FIG. 3 A cross-sectional view along line III-III in FIG. 2.

FIG. 4 A view showing the discharge device during the inverted attitude in FIG. 2.

FIG. 5 A longitudinal cross-sectional view of a discharge device having a unit for upright and inverted attitudes shown as a second embodiment according to the present invention.

FIG. 6 An enlarged view of the unit for upright and inverted attitudes of FIG. 5.

FIG. 7 A view showing the discharge device in FIG. 6 during the inverted attitude.

### DESCRIPTION OF EMBODIMENTS

### First Embodiment

Hereinafter, a unit for upright and inverted attitudes according to a first embodiment of the present invention will be described with reference to the accompanying drawings.

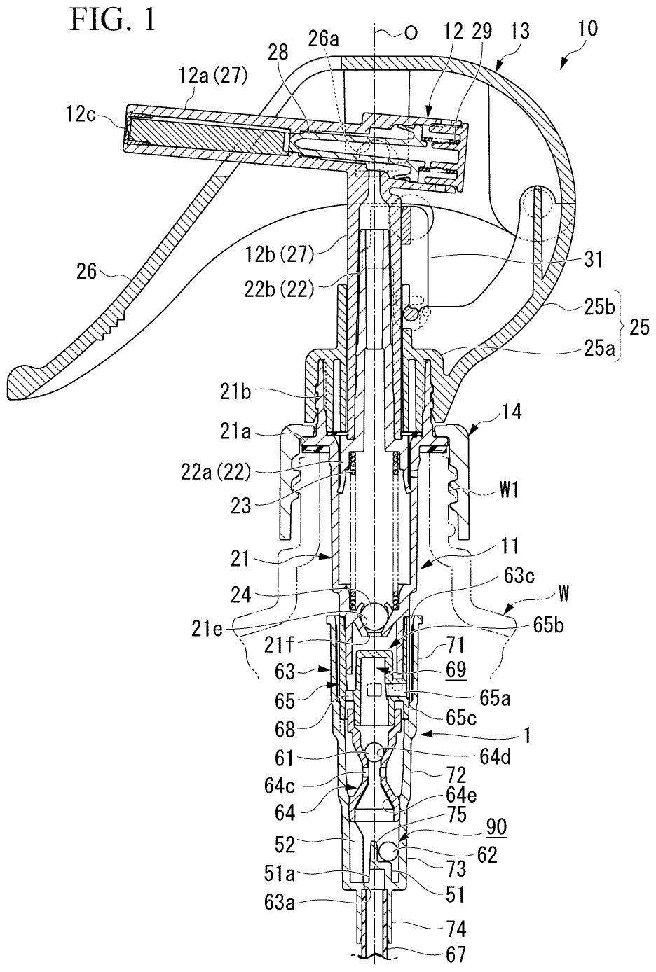

As shown in FIG. 1, a unit 1 for upright and inverted attitudes constitutes a part of a discharge device 10 including a pump 11, a discharge head 12, a pressing member 13, and a mounting cap 14.

First, the pump 11, the discharge head 12, the pressing member 13, and the mounting cap 14 will be described.

The pump 11 includes a cylinder part 21, a piston part 22, a first biasing member 23, and a lower valve body 24. A content liquid in a container main body W is introduced into the cylinder part 21 through a content liquid inlet 21f by a decrease in an internal pressure due to an increase in an internal volume of the cylinder part 21, and the content liquid in the cylinder part 21 is sent to the discharge head 12 by an increase in an internal pressure due to a decrease in an internal volume of the cylinder part 21.

Each of the cylinder part 21, the piston part 22, and the first biasing member 23 is formed in a tubular shape and is arranged coaxially with a common shaft.

Hereinafter, the common shaft is referred to as an axis O, a side of the discharge head 12 in an axis O direction is referred to as an upper side, a side of the unit 1 for upright and inverted attitudes in the axis O direction is referred to as a lower side, and a direction along the axis O is referred to as an upward/downward direction. A direction crossing the axis O when seen in the upward/downward direction is referred to as a radial direction, and a direction around the axis O when seen in the upward/downward direction is referred to as a circumferential direction.

The cylinder part 21 is inserted into a mouth portion W1 of the container main body W in which a content liquid is accommodated. A flange portion 21a protruding outward in the radial direction is formed on the cylinder part 21. The flange portion 21a is placed on an upper end opening edge of the mouth portion W1 via a packing. A first connecting tube portion 21b protruding upward is formed on the flange portion 21a. The first connecting tube portion 21b is disposed coaxially with the axis O.

The piston part 22 includes a topped tubular sliding portion 22a having an annular top wall, and a tube portion 22b extending upward from an inner circumferential edge portion of a top wall of the sliding portion 22a. The sliding portion 22a is vertically slidably fitted into the cylinder part 21. The tube portion 22b is inserted into the first connecting tube portion 21b, and an upper end portion of the tube portion 22b protrudes upward from the first connecting tube portion 21b.

An upper end portion of the first biasing member 23 is inserted into the sliding portion 22a, and abuts a lower surface of the top wall of the sliding portion 22a. A lower tip portion of the first biasing member 23 abuts a stepped portion formed on an inner circumferential surface of the cylinder part 21 and facing upward. The first biasing member 23 is a coil spring extending in the upward/downward direction.

The lower valve body 24 is, for example, a ball valve, and is provided in a lower tip portion of the cylinder part 21. A valve seat portion 21e protruding inward in the radial direction and having a diameter reduced downward is formed on an inner circumferential surface of the lower tip portion of the cylinder part 21. A lower end opening of the valve seat portion 21e is the content liquid inlet 21f through which the content liquid in the container main body W is introduced into the cylinder part 21. The lower valve body 24 is mounted upwardly and separably on the upper surface of the valve seat portion 21e. The lower valve body 24 is a check valve configured to cut off communication between the inside of the container main body W and the inside of the cylinder part 21 during pressurization in the cylinder part 21 and allow communication between the inside of the container main body W and the inside of the cylinder part 21 during decompression in the cylinder part 21.

The mounting cap 14 is mounted on the mouth portion W1. The mounting cap 14 is formed in a topped tubular shape having an annular top wall, and the first connecting tube portion 21b is inserted into the top wall. The flange portion 21a is sandwiched and fixed between the lower surface of the top wall and the upper end opening edge of the mouth portion W1 in the upward/downward direction.

The pressing member 13 includes a support portion 25, and a lever portion 26.

The support portion 25 includes a topped tubular second connecting tube portion 25a fitted onto the first connecting tube portion 21b, and a protrusion portion 25b protruding upward from the second connecting tube portion 25a. A top wall of the second connecting tube portion 25a is formed in an annular shape, the tube portion 22b of the piston part 22 is inserted thereinside. An upper end portion of the tube portion 22b protrudes upward from the second connecting tube portion 25a. The protrusion portion 25b is separated from the axis O in the radial direction.

Hereinafter, in the radial direction, a side where the protrusion portion 25b is separated from the axis O is referred to as a rear side, and a side opposite thereto is referred to as a front side.

A rear portion of the lever portion 26 extends forward from the upper end portion of the protrusion portion 25b and straddles the axis O in the forward/rearward direction. A front portion of the lever portion 26 extends downward from a front tip portion of the rear portion of the lever portion 26. The lever portion 26 is provided rotatably around the upper end portion of the protrusion portion 25b in the upward/downward direction. The lever portion 26 has an engagement portion 26a engaged with the discharge head 12. As the lever portion 26 rotates downward around the upper end portion of the protrusion portion 25b, the engagement portion 26a presses down on the discharge head 12.

A restriction member 31 movably provided between a restriction position where downward rotation of the lever portion 26 is restricted and a permitted position where downward rotation of the lever portion 26 is permitted is attached to the support portion 25.

The discharge head 12 includes a main body portion 27, an accumulator valve 28, and a second biasing member 29.

The main body portion 27 includes a horizontal tube 12a extending in the radial direction, and a vertical tube 12b extending downward from the horizontal tube 12a. The horizontal tube 12a extends in the forward/rearward direction and passes through the front portion of the lever portion 26 in the forward/rearward direction. A discharge hole 12c that opens forward is formed in a front tip portion of the horizontal tube 12a. The vertical tube 12b extends downward from a rear portion of the horizontal tube 12a. The vertical tube 12b is fitted onto the tube portion 22b of the piston part 22.

The accumulator valve 28 is provided in the horizontal tube 12a, and cuts off communication between the inside of the vertical tube 12b and the discharge hole 12c. The accumulator valve 28 is provided within the rear portion of the horizontal tube 12a so as to be movable back and forth, and is biased forward by the second biasing member 29. When an internal pressure of the rear portion of the horizontal tube 12a exceeds a predetermined value, the accumulator valve 28 moves backward against the biasing force of the second biasing member 29. Accordingly, communication is established between the inside of the vertical tube 12b and the discharge hole 12c, and the content liquid is discharged from the discharge hole 12c.

Next, the unit 1 for upright and inverted attitudes will be described.

The unit 1 for upright and inverted attitudes is attached to the cylinder part 21. The unit 1 for upright and inverted attitudes includes a first switching valve 61, a second switching valve 62, an outer tube member 63, an inner tube member 64, and a channel forming member 65. The outer tube member 63 and the inner tube member 64 are arranged coaxially with the axis O.

The channel forming member 65 has an inverted-attitude inlet 65a through which the content liquid in the container main body W can be introduced into the content liquid inlet 21f of the cylinder part 21 during an inverted attitude of the discharge device 10. The channel forming member 65 is formed in a bottomed tubular shape and fitted onto a lower tip portion of the cylinder part 21. A seal tube portion 65c protruding downward is formed on an outer circumferential edge portion of a bottom wall portion of the channel forming member 65.

The outer tube member 63 is fitted onto the cylinder part 21 via the channel forming member 65. The outer tube member 63 has an upright-attitude inlet 63a through which the content liquid in the container main body W can be introduced into the content liquid inlet 21f of the cylinder part 21 during an upright attitude of the discharge device 10, and an intake hole 63c through which the content liquid in the container main body W can be introduced into the inverted-attitude inlet 65a during the inverted attitude of the discharge device 10.

The upright-attitude inlet 63a and the intake hole 63c open in the container main body W. The intake hole 63c and the inverted-attitude inlet 65a are located above the upright-attitude inlet 63a during the upright attitude of the discharge device 10.

The outer tube member 63 is formed in a multi-stage tubular shape having a diameter gradually decreased downward. The outer tube member 63 is constituted by, from top to bottom, a first outer tube portion 71, a second outer tube portion 72, a third outer tube portion 73, and a fourth outer tube portion 74, lined up in this order.

The first outer tube portion 71 surrounds the outer circumferential surface of the channel forming member 65 with a gap in the radial direction. An annular gap extending in the circumferential direction is provided between the outer circumferential surface of the channel forming member 65 and the inner circumferential surface of the first outer tube portion 71. The inverted-attitude inlet 65a opens in the gap. An upper end opening of the first outer tube portion 71 is the intake hole 63c. The seal tube portion 65c of the channel forming member 65 is closely fitted into the lower tip portion of the first outer tube portion 71.

Further, the first outer tube portion 71 may have only a lower tip portion fitted onto the seal tube portion 65c, and no portion located above the lower tip portion and no intake hole 63c, with the inverted-attitude inlet 65a opening into the container main body W.

A relay port 64c of the inner tube member 64, which will be described below, opens in the second outer tube portion 72.

A lower tip portion of the inner tube member 64 is closely fitted into the upper end portion of the third outer tube portion 73. A lower end opening of the third outer tube portion 73 is the upright-attitude inlet 63a that opens in the upward/downward direction. The second switching valve 62 is movably accommodated in the third outer tube portion 73. The second switching valve 62 is, for example, a ball valve.

An upper end portion of a suction tube 67 is fitted into the fourth outer tube portion 74. A lower tip portion of the suction tube 67 is located at the bottom portion of the container main body W. The upright-attitude inlet 63a is in communication with the inside of the container main body W through the suction tube 67. Further, a configuration may be adopted in which the fourth outer tube portion 74 is not provided and the upper end portion of the suction tube 67 is connected to, for example, the third outer tube portion 73.

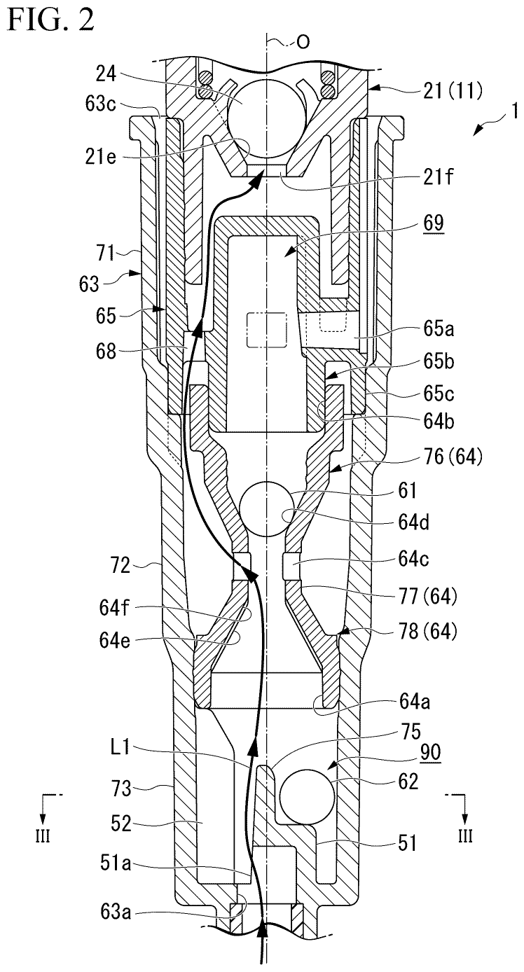

As shown in FIG. 2, the inner tube member 64 has a lower end opening 64a in communication with the upright-attitude inlet 63a, an upper end opening 64b in communication with the inverted-attitude inlet 65a, and the relay port 64c that can communicate with the content liquid inlet 21f, the upright-attitude inlet 63a, and the inverted-attitude inlet 65a. The relay port 64c is in communication with each of the content liquid inlet 21f, the upright-attitude inlet 63a, and the inverted-attitude inlet 65a through different flow paths.

The inner tube member 64 is formed in a gourd shape (a shape like a gourd) with the intermediate portion in the upward/downward direction being constricted inward in the radial direction. An upper end portion of the inner tube member 64 is connected to a bottom wall portion of the channel forming member 65. The inner tube member 64 is constituted by, from top to bottom, a first inner tube portion 76, a second inner tube portion 77, and a third inner tube portion 78, lined up in this order.

The upper end opening of the first inner tube portion 76 is the upper end opening 64b of the inner tube member 64. An upright-attitude valve seat 64d extending upward is formed on an inner circumferential surface of a lower portion of the first inner tube portion 76. The upright-attitude valve seat 64d extends inward in the radial direction as it goes downward.

The first switching valve 61 enters a second path L2, which will be described below, during the upright attitude of the discharge device 10, and abuts against the upright-attitude valve seat 64d, cutting off communication between the inverted-attitude inlet 65a and the relay port 64c. The first switching valve 61 is disposed above the upright-attitude valve seat 64d. The first switching valve 61 is, for example, a ball valve, and is abutting the upright-attitude valve seat 64d to be separable upward.

The second inner tube portion 77 configures a constricted portion of the inner tube member 64. The plurality of relay ports 64c passing in the radial direction are formed in the second inner tube portion 77 at intervals in the circumferential direction.

A lower end opening of the third inner tube portion 78 is the lower end opening 64a of the inner tube member 64. A lower tip portion of the third inner tube portion 78 is fitted into an upper end portion of the third outer tube portion 73 of the outer tube member 63. An inverted-attitude valve seat 64e extending downward is formed on an inner circumferential surface of the upper portion of the third inner tube portion 78. The inverted-attitude valve seat 64e extends inward in the radial direction as it goes upward.

The second switching valve 62 is disposed below the inverted-attitude valve seat 64e. The second switching valve 62 is disposed to be able to abut the inverted-attitude valve seat 64e from below. The second switching valve 62 enters a first path L1, which will be described below, during the inverted attitude of the discharge device 10, and abuts the inverted-attitude valve seat 64e, and cutting off communication between the upright-attitude inlet 63a and the relay port 64c.

An anti-sticking portion 64f configured to prevent sticking of the second switching valve 62 is formed on the inverted-attitude valve seat 64e. The anti-sticking portion 64f can be, for example, a groove or rib provided radially on the inverted-attitude valve seat 64e, but may be changed as appropriate to any irregularity that can prevent sticking of the second switching valve 62. The anti-sticking portion 64f does not need to be formed on the inverted-attitude valve seat 64e. In this case, the inner tube member 64 may be formed in a vertically symmetrical shape, and when the discharge device 10 is in the inverted attitude, the sealability between the second switching valve 62 and the inverted-attitude valve seat 64e is improved, and communication between the upright-attitude inlet 63a and the relay port 64c can be reliably cut off.

A plug (topped tubular portion) 65b and a common channel 68 are formed in a bottom wall portion of the channel forming member 65.

The plug 65b is provided radially inward from the seal tube portion 65c. The plug 65b protrudes on both sides in the upward/downward direction from the bottom wall portion of the channel forming member 65. A part of the plug 65b that protrudes downward from the bottom wall portion of the channel forming member 65 is fitted into the upper end opening 64b of the inner tube member 64. The plug 65b is formed in a topped tubular shape extending in the upward/downward direction. The inverted-attitude inlet 65a is formed in a portion of the circumferential wall of the plug 65b that is located below the upper end portion. The inverted-attitude inlet 65a extends in the radial direction, penetrates a bottom wall portion of the channel forming member 65 in the radial direction, opens to the inner circumferential surface of the plug 65b and the outer circumferential surface of the channel forming member 65, and communicates with the intake hole 63c.

The common channel 68 is in communication with the content liquid inlet 21f of the cylinder part 21 and the relay port 64c. The common channel 68 penetrates in the upward/downward direction through the bottom wall portion of the channel forming member 65 located between the plug 65b and the seal tube portion 65c, and opens into the channel forming member 65. The common channel 68 opens toward the upper end opening edge of the first inner tube portion 76.

Here, an upper end portion of the first inner tube portion 76 is inserted into the seal tube portion 65c. An annular gap extending in the circumferential direction is provided between the inner circumferential surface of the seal tube portion 65c and the outer circumferential surface of the first inner tube portion 76. A lower surface of the bottom wall portion of the channel forming member 65 is separated upward from the upper end opening edge of the first inner tube portion 76. An annular gap between the inner circumferential surface of the seal tube portion 65c and the outer circumferential surface of the first inner tube portion 76 is in communication with the common channel 68.

Here, in the embodiment, the unit 1 for upright and inverted attitudes includes at least one of a prevention part 75 (first prevention part) and a prevention part (second prevention part), the prevention part 75 (first prevention part) being configured to prevent the second switching valve 62 from entering the first path L1 through which the content liquid is directed toward the relay port 64c from the upright-attitude inlet 63a during the upright attitude of the discharge device 10, and the prevention part (second prevention part) being configured to prevent the first switching valve 61 from entering the second path L2 through which the content liquid is directed toward the relay port 64c from the inverted-attitude inlet 65a during the inverted attitude of the discharge device 10.

Further, the prevention part (second prevention part) of the latter with respect to the first switching valve 61 is provided on the plug 65b. In the case of the embodiment, the prevention part (second prevention part) of the latter with respect to the first switching valve 61 is an escape recess 69 (second escape recess), which will be described below.

In the example shown, a topped tubular covering portion 51 protruding upward and configured to cover the upright-attitude inlet 63a from above is formed on an opening circumferential edge portion of the upright-attitude inlet 63a in the inner surface of the outer tube member 63. A side opening 51a that opens in the radial direction and brings the upright-attitude inlet 63a and the inside of the third outer tube portion 73 in communication with each other is formed in a circumferential wall of the covering portion 51. The prevention part 75 with respect to the above-mentioned second switching valve 62 protrudes upward from the top wall of the covering portion 51.

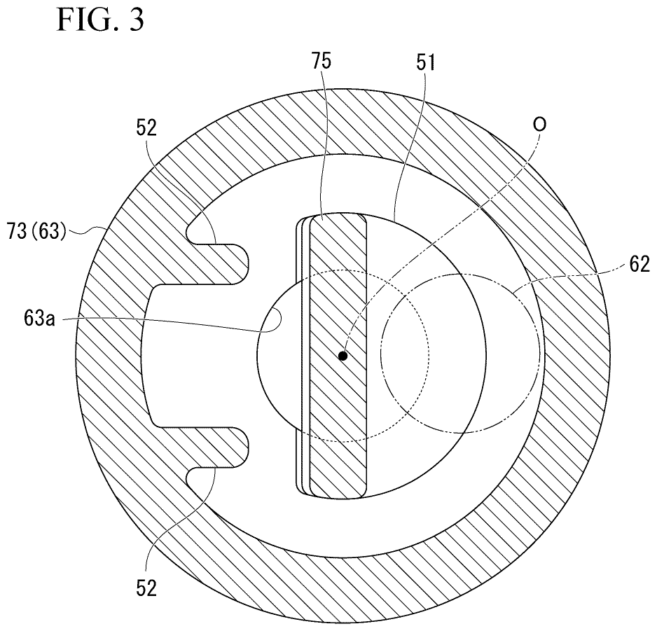

A protrusion amount of the prevention part 75 (first prevention part) protruding upward from the top wall of the covering portion 51 is equal to an outer diameter of the second switching valve 62. As shown in FIG. 3, when seen in the upward/downward direction, the prevention part 75 is formed like a plate whose front surface faces the side where the side opening 51a is open in the radial direction. The prevention part 75 is located at a tip portion of the top wall of the covering portion 51 at a side where the side opening 51a in the radial direction is open. As shown in FIG. 2, when seen in a longitudinal cross-sectional view in the upward/downward direction, a front surface of the prevention part 75 is located on the same straight line as the opening surface of the side opening 51a. Since the prevention part 75 is formed in a plate shape as described above, it is less likely to cause space constraints compared to, for example, a configuration in which it is formed in a cylindrical shape extending continuously around the entire circumference.

An interval between a part of the inner circumferential surface of the third outer tube portion 73 facing a back surface of the prevention part 75 (first prevention part) in the radial direction and the back surface of the prevention part 75 is greater than an outer diameter of the second switching valve 62. An interval between a part of the inner circumferential surface of the third outer tube portion 73 facing an outer circumferential surface of the circumferential wall of the covering portion 51 in the radial direction and the outer circumferential surface of the circumferential wall of the covering portion 51 is smaller than the outer diameter of the second switching valve 62.

The second switching valve 62 is located in a space (i.e., an escape recess 90) surrounded by the back surface of the prevention part 75, the upper surface of the top wall of the covering portion 51 and the inner circumferential surface of the third outer tube portion 73, during the upright attitude of the discharge device 10.

An interval between a part of the inner circumferential surface of the third outer tube portion 73 facing the side opening 51a and the front surface of the prevention part 75 (first prevention part) in the radial direction and the side opening 51a and the front surface of the prevention part 75 is greater than the outer diameter of the second switching valve 62.

A space (gap) between a part of the inner circumferential surface of the third outer tube portion 73 facing the side opening 51a and the front surface of the prevention part 75 in the radial direction and the side opening 51a and the front surface of the prevention part 75 is an inlet portion of the first path L1 through which the content liquid is directed toward the relay port 64c from the upright-attitude inlet 63a, and a guide portion 52 configured to guide the second switching valve 62 attempting to enter the inlet portion toward the back surface of the prevention part 75 during the upright attitude of the discharge device 10 is provided inside the third outer tube portion 73.

The guide portion 52 protrudes inward in the radial direction from a part of the inner circumferential surface of the third outer tube portion 73 facing the side opening 51a and the front surface of the prevention part 75 in the radial direction. The guide portion 52 extends upward from a lower tip portion of the third outer tube portion 73. The upper end portion of the guide portion 52 is located above the upper end portion of the prevention part 75, and abuts against the lower tip portion of the inner tube member 64 in the upward/downward direction. The upper end portion of the guide portion 52 extends outward in the radial direction as it goes upward. The guide portion 52 is formed in a plate shape with front and back surfaces facing in the circumferential direction. As shown in FIG. 3, the guide portion 52 is provided on each side of the inner circumferential surface of the third outer tube portion 73, sandwiching in the circumferential direction the central portion in the circumferential direction of the side opening 51a and the prevention part 75 and the portions that face each other in the radial direction.

Here, in the embodiment, there is provided at least one of the escape recess 90 (first escape recess) and the escape recess 69 (a second escape recess and a second prevention part), the escape recess 90 (first escape recess) being configured to allow the second switching valve 62 to enter thereinto and separate the second switching valve 62 from the first path L1 on a side opposite to the inverted-attitude valve seat 64e and in a direction crossing an opening direction of the upright-attitude inlet 63a during the upright attitude of the discharge device 10, and the escape recess 69 (a second escape recess and a second prevention part) being configured to allow the first switching valve 61 to enter thereinto and separate the first switching valve 61 from the second path L2 on a side opposite to the upright-attitude valve seat 64d and a direction crossing the opening direction of the inverted-attitude inlet 65a during the inverted attitude of the discharge device 10.

Further, it is possible to adopt a configuration in which, as the escape recess 90 (first escape recess) of the former with respect to the second switching valve 62, for example, in the inner circumferential surface of the third outer tube portion 73, an interval between the portion facing the outer circumferential surface of the circumferential wall of the covering portion 51 in the radial direction and the outer circumferential surface of the circumferential wall of the covering portion 51 is greater than the outer diameter of the second switching valve 62, and the gap portion is recessed below the upright-attitude inlet 63a.

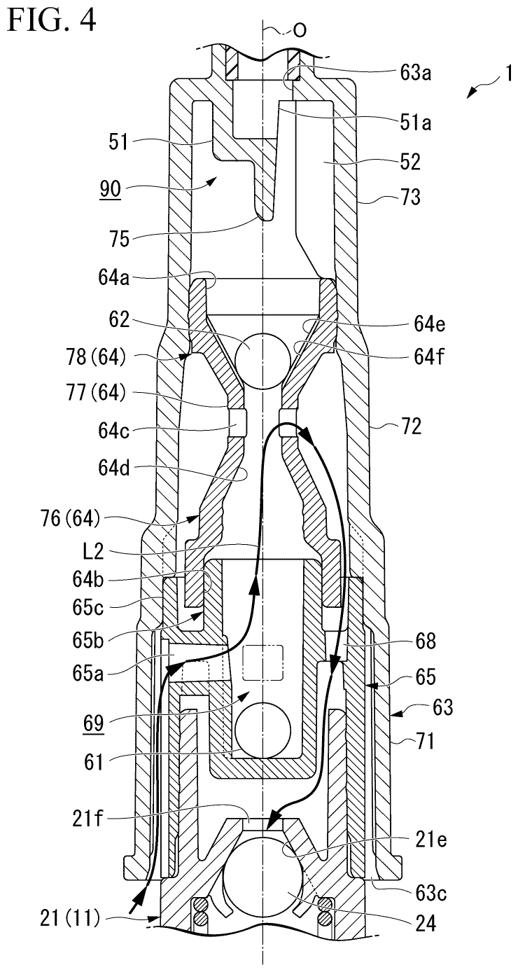

In the example shown, in the inside of the plug 65b, the portion located above the inverted-attitude inlet 65a is the escape recess 69 (a second escape recess or a second prevention part) into which the first switching valve 61 enters during the inverted attitude of the discharge device 10. As shown in FIG. 4, the first switching valve 61 entering the escape recess 69 is separated from the second path L2 in a direction crossing the upward/downward direction, i.e., from the second path L2 in a direction crossing the opening direction of the inverted-attitude inlet 65a.

Next, an action of the discharge device 10 will be described.

When the lever portion 26 is rotated downward around the upper end portion of the protrusion portion 25b to push down the discharge head 12, the piston part 22 is pushed down together with the discharge head 12 against the biasing force of the first biasing member 23. Here, the sliding portion 22a of the piston part 22 slides downward on the inner circumferential surface of the cylinder part 21, reducing the internal volume of the cylinder part 21, thereby pressurizing the inside of the cylinder part 21. As the internal pressure in the cylinder part 21 increases, the lower valve body 24 in the cylinder part 21 comes into close contact with the valve seat portion 21e, cutting off communication between the inside of the cylinder part 21 and the inside of the container main body W. Accordingly, the content liquid pressurized in the cylinder part 21 rises inside the tube portion 22b of the piston part 22 and flows into the rear portion of the horizontal tube 12a through the vertical tube 12b of the discharge head 12, thereby pressurizing the rear portion of the horizontal tube 12a. Then, when the internal pressure in the rear portion of the horizontal tube 12a exceeds a predetermined value, the accumulator valve 28 moves rearward against the biasing force of the second biasing member 29, thereby communicating between the inside of the vertical tube 12b and the discharge hole 12c, and discharging the content liquid from the discharge hole 12c.

After that, when the discharge head 12 is released from the depressed state, the piston part 22 rises together with the discharge head 12 due to the upward biasing force of the first biasing member 23.

When the piston part 22 slides upward along the inner circumferential surface of the cylinder part 21, the space enclosed by the inner circumferential surface of the cylinder part 21 and the inner circumferential surface of the piston part 22 increases, causing decompression inside the cylinder part 21. Due to the reduction in the internal pressure of the cylinder part 21, the lower valve body 24 moves upward from the upper surface of the valve seat portion 21e, the content liquid inlet 21f is opened, and a main flow path from the content liquid inlet 21f to the relay port 64c becomes decompressed.

The main flow path includes a gap between the common channel 68, the lower surface of the bottom wall portion of the channel forming member 65 and the upper end opening edge of the first inner tube portion 76, a gap between the inner circumferential surface of the seal tube portion 65c and the outer circumferential surface of the first inner tube portion 76, a gap between the inner circumferential surface of the second outer tube portion 72 and the outer circumferential surface of the first inner tube portion 76, and a gap between the inner circumferential surface of the second outer tube portion 72 and the outer circumferential surface of the second inner tube portion 77, inside the channel forming member 65.

When the main flow path enters the decompression state, during the upright attitude of the discharge device 10, the first switching valve 61 is close to the upright-attitude valve seat 64d and communication between the inverted-attitude inlet 65a and the relay port 64c is cut off. For this reason, the inside of the third inner tube portion 78 and the inside of the third outer tube portion 73 are decompressed through the relay port 64c and the inside of the second inner tube portion 77. Accordingly, the flow path for the upright attitude, which runs from the content liquid inlet 21f through the main flow path, the relay port 64c, the inside of the second inner tube portion 77, the inside of the third inner tube portion 78, the inside of the third outer tube portion 73, the upright-attitude inlet 63a, and the inside of the suction tube 67 to the inside of the container main body W, becomes decompressed, and the content liquid in the container main body W is sucked up into the cylinder part 21.

Here, the second switching valve 62 is separated from the first path L1 of the content liquid flowing from the upright-attitude inlet 63a to the relay port 64c by the prevention part 75. Accordingly, it is possible to prevent the content liquid flowing through the first path LI from coming into contact with the second switching valve 62.

Meanwhile, during the inverted attitude of the discharge device 10, as shown in FIG. 4, the first switching valve 61 moves away from the upright-attitude valve seat 64d due to its own weight, establishing communication between the inverted-attitude inlet 65a and the relay port 64c, and the second switching valve 62 moves closely to the inverted-attitude valve seat 64e due to its own weight, cutting off communication between the upright-attitude inlet 63a and the relay port 64c. In this state, when the discharge head 12 moves back to its original position after discharging the content liquid, similar to during the upright attitude of the discharge device 10 described above, the lower valve body 24 moves away from the valve seat portion 21e, opening the content liquid inlet 21f and causing the main flow path from the content liquid inlet 21f to the relay port 64c to be in a decompressed state, and therefore, the flow path for the inverted attitude from the relay port 64c through the inverted-attitude inlet 65a to the intake hole 63c also is caused to be in a decompressed state.

The flow path during the inverted attitude includes the inside of the second inner tube portion 77, the inside of the first inner tube portion 76, the inside of the plug 65b, the inverted-attitude inlet 65a, and a gap between the outer circumferential surface of the channel forming member 65 and the inner circumferential surface of the first outer tube portion 71.

When the flow path during the inverted attitude is in a decompression state, during the inverted attitude of the discharge device 10, the content liquid in the container main body W is introduced into the content liquid inlet 21f through the intake hole 63c, the flow path during the inverted attitude, the relay port 64c, and the main flow path.

During the inverted attitude of the discharge device 10, the first switching valve 61 enters the plug 65b, reaches the escape recess 69 (the second escape recess and the second prevention part) in the plug 65b, and abuts the top wall of the plug 65b. Here, the first switching valve 61 is separated from the inverted-attitude inlet 65a in the upward/downward direction. Accordingly, the first switching valve 61 is separated from the second path L2 of the content liquid from the inverted-attitude inlet 65a toward the relay port 64c in the upward/downward direction, preventing the content liquid flowing through the second path L2 from coming into contact with the first switching valve 61.

As described above, according to the unit 1 for upright and inverted attitudes of the embodiment, the unit 1 for upright and inverted attitudes includes at least one prevention part of the prevention part 75 (first prevention part) configured to prevent the second switching valve 62 from entering the first path L1 during the upright attitude of the discharge device 10 and the prevention part (second prevention part) configured to prevent the first switching valve 61 from entering the second path L2 during the inverted attitude of the discharge device 10. In the case of the embodiment, the prevention part (second prevention part) is the escape recess 69 (second escape recess). Accordingly, when the content liquid in the container main body W is introduced into the content liquid inlet 21f, it is possible to do at least one of the preventing the content liquid flowing through the first path L1 from coming into contact with the second switching valve 62, the second switching valve 62 from riding the liquid flow of the content liquid and approaching the inverted-attitude valve seat 64e, during the upright attitude of the discharge device 10, and the preventing the content liquid flowing through the second path L2 from coming into contact with the first switching valve 61, the first switching valve 61 from riding the liquid flow of the content liquid and approaching the upright-attitude valve seat 64d, during the inverted attitude of the discharge device 10.

Accordingly, when the content liquid is introduced into the content liquid inlet 21f, it is possible to do at least one of the preventing the second switching valve 62 from being pressed against the inverted-attitude valve seat 64e due to decompression in the cylinder part 21 acting through the relay port 64c during the upright attitude of the discharge device 10, and the preventing the first switching valve 61 from being pressed against the upright-attitude valve seat 64d due to decompression in the cylinder part 21 acting through the relay port 64c during the inverted attitude of the discharge device 10, making it possible to smoothly introduce the content liquid in the container main body W into the cylinder part 21.

The side opening 51a that communicates with the upright-attitude inlet 63a and the inside of the outer tube member 63 is formed in the circumferential wall of the covering portion 51 and the prevention part 75 (first prevention part) protrudes upward from the top wall of the covering portion 51. Accordingly, during the upright attitude of the discharge device 10, by positioning the second switching valve 62 in the space (i.e., the escape recess 90) surrounded by the back surface of the prevention part 75, the upper surface of the top wall of the covering portion 51 and the inner circumferential surface of the outer tube member 63, the second switching valve 62 can be reliably prevented from entering the first path L1.

The guide portion 52 is provided on the inside of the outer tube member 63, which guides the second switching valve 62, which attempts to enter the inlet portion of the first path L1 during the upright attitude of the discharge device 10, to the back surface side of the prevention part 75 (the first prevention part). Accordingly, the second switching valve 62 can be reliably prevented from entering the first path L1.

The unit 1 for upright and inverted attitudes includes at least one escape recess of the escape recess 90 (the first escape recess) configured to allow the second switching valve 62 to enter therein and separate the second switching valve 62 from the first path L1 on a side opposite to the inverted-attitude valve seat 64e and in a direction crossing the opening direction of the upright-attitude inlet 63a during the upright attitude of the discharge device 10, and the escape recess 69 (the second escape recess and the second prevention part) configured to allow the first switching valve 61 to enter therein and separate the first switching valve 61 from the second path L2 on a side opposite to the upright-attitude valve seat 64d and in a direction crossing the opening direction of the inverted-attitude inlet 65a during the inverted attitude of the discharge device 10. In the case of the embodiment, the escape recess 69 (the second escape recess) is the prevention part (the second prevention part). Accordingly, when the content liquid in the container main body W is introduced into the content liquid inlet 21f, it is possible to do at least one of the preventing the content liquid flowing through the first path L1 from coming into contact with the second switching valve 62, the second switching valve 62 from riding the liquid flow of the content liquid and approaching the inverted-attitude valve seat 64e, during the upright attitude of the discharge device 10, and the preventing the content liquid flowing through the second path L2 from coming into contact with the first switching valve 61, the first switching valve 61 from riding the liquid flow of the content liquid and approaching the upright-attitude valve seat 64d, during the inverted attitude of the discharge device 10.

Accordingly, when the content liquid is introduced into the content liquid inlet 21f, it is possible to do the preventing the second switching valve 62 from being pressed against the inverted-attitude valve seat 64e due to decompression in the cylinder part 21 exerted through the relay port 64c during the upright attitude of the discharge device 10 and the preventing the first switching valve 61 from being pressed against the upright-attitude valve seat 64d due to decompression in the cylinder part 21 exerted through the relay port 64c during the inverted attitude of the discharge device 10, and thus, it is possible to smoothly introduce the content liquid in the container main body W into the cylinder part 21.

The channel forming member 65 in which the common channel 68 that communicates with the content liquid inlet 21f and the relay port 64c is formed includes the plug (topped tubular portion) 65b, and the portion of the plug 65b located above the inverted-attitude inlet 65a is the escape recess 69 (the second escape recess and the second prevention part) into which the first switching valve 61 enters during the inverted attitude of the discharge device 10. Accordingly, it is possible to obtain the unit 1 for upright and inverted attitudes capable of smoothly introducing the content liquid in the container main body W into the cylinder part 21 while suppressing complexity of the structure.

### Second Embodiment

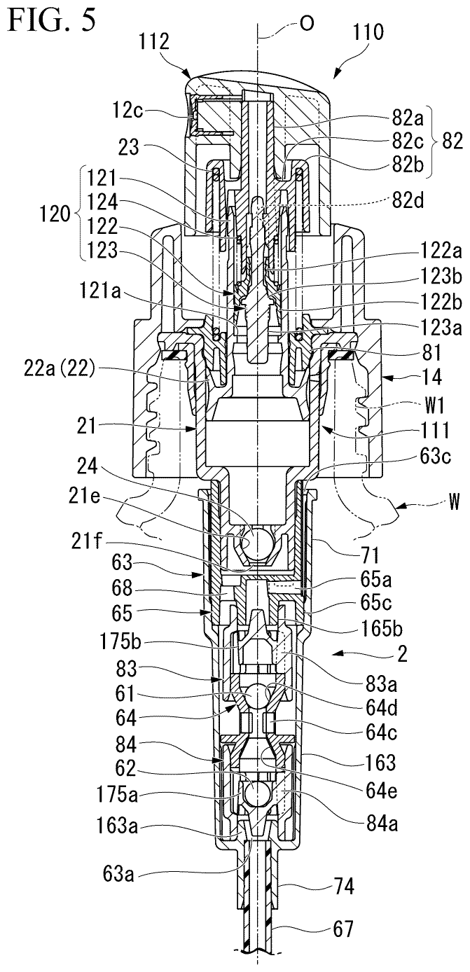

Next, a unit 2 for upright and inverted attitudes according to a second embodiment of the present invention will be described with reference to FIG. 5 to FIG. 7.

Further, in the second embodiment, the same parts as the components in the first embodiment are designated by the same reference signs, and description thereof will be omitted and only different points will be described.

The unit 2 for upright and inverted attitudes constitutes a part of a discharge device 110 including a pump 111, a discharge head 112, and a mounting cap 14.

First, the pump 111 and the discharge head 112 will be described.

The pump 111 includes a cylinder part 21, a piston part 22, a first biasing member 23, a lower valve body 24, a lower support tube 81, a stem 82, and an accumulator mechanism 120.

The lower support tube 81 and the stem 82 are disposed coaxially with the axis O.

The lower support tube 81 is fitted into an upper end portion of the cylinder part 21.

The stem 82 includes a stem tube 82a and an upper support tube 82b.

The upper support tube 82b is formed into a double cylindrical shape arranged coaxially with the axis O. The upper support tube 82b surrounds the stem tube 82a. The upper end portion of the upper support tube 82b is located below the upper end portion of the stem tube 82a. The upper support tube 82b is connected to the stem tube 82a via a plurality of connecting pieces 82c arranged in the circumferential direction.

The first biasing member 23 surrounds the stem tube 82a and is sandwiched in the upward/downward direction by the upper support tube 82b and the lower support tube 81. Accordingly, the first biasing member 23 supports the stem 82 in an upwardly biased state so as to be movable downward.

The accumulator mechanism 120 includes an accumulator cylinder 121, an accumulator piston 122, an accumulator valve body 123, and a third biasing member 124.

The accumulator mechanism 120 provides auxiliary pressurization inside the cylinder part 21 when the piston part 22 descends to send the content liquid inside the cylinder part 21 toward the discharge hole 12c.

The accumulator cylinder 121 is provided above the sliding portion 22a of the piston part 22 and formed in a tubular shape disposed coaxially with the axis O. The accumulator cylinder 121 and the piston part 22 are formed integrally with each other.

The accumulator cylinder 121 passes through the lower support tube 81 in the upward/downward direction. A lower end opening portion of the accumulator cylinder 121 is located in the cylinder part 21. A lower edge of the accumulator cylinder 121 is located below the lower support tube 81 and connected to the sliding portion 22a of the piston part 22. An upper end portion of the accumulator cylinder 121 is inserted between the stem tube 82a and the upper support tube 82b. A gap in the upward/downward direction is provided between the upper edge of the accumulator cylinder 121 and the connecting pieces 82c. Further, the accumulator cylinder 121 and the piston part 22 may be formed separately from each other.

The accumulator piston 122 is disposed between the accumulator cylinder 121 and the stem tube 82a. The accumulator piston 122 is disposed coaxially with the axis O and formed in a multi-stage tubular shape having an outer diameter that is reduced as it goes upward. In the accumulator piston 122, a piston small diameter portion 122a located at the top is inserted into the stem tube 82a through the lower end opening portion of the stem tube 82a, and a piston large diameter portion 122b located at the bottom is fitted into the accumulator cylinder 121. When the accumulator piston 122 moves up and down relative to the accumulator cylinder 121, the piston large diameter portion 122b slides closely in the upward/downward direction on the inner circumferential surface of the accumulator cylinder 121. The piston large diameter portion 122b is located above a locking protrusion 121a formed on an inner circumferential surface of the accumulator cylinder 121.

The accumulator valve body 123 is disposed between the stem tube 82a and the accumulator piston 122. The accumulator valve body 123 includes a column 123a and a seating portion 123b.

The column 123a is formed in a columnar shape disposed coaxially with the axis O. An upper end portion of the column 123a is fitted and fixed into the stem tube 82a. The accumulator valve body 123 is vertically movable together with the stem 82. A communication groove 82d is formed in a portion of the inner circumferential surface of the stem tube 82a into which the column 123a is fitted. The plurality of communication grooves 82d extending in the upward/downward direction are formed at intervals in the circumferential direction. The inside of the stem tube 82a communicates in the upward/downward direction through the communication groove 82d. A gap in the radial direction is provided between the outer circumferential surface of the column 123a and the inner circumferential surface of the piston small diameter portion 122a.

The seating portion 123b overhangs outward in the radial direction from an intermediate portion of the column 123a in the upward/downward direction. The seating portion 123b is configured to be separable from the lower edge of the piston small diameter portion 122a according to vertical movement relative to the accumulator piston 122. That is, the seating portion 123b seats on the lower edge of the piston small diameter portion 122a, blocking communication between the inside of the accumulator cylinder 121 and the inside of the stem tube 82a through the accumulator piston 122.

Meanwhile, the seating portion 123b is separated downward from the lower edge of the piston small diameter portion 122a to bring the inside of the accumulator cylinder 121 and the inside of the stem tube 82a in communication with each other through the accumulator piston 122.

The third biasing member 124 is a coil spring extending in the upward/downward direction. The third biasing member 124 is disposed in the gap in the upward/downward direction between the stem tube 82a and the accumulator piston 122 within the accumulator cylinder 121, surrounding the lower tip portion of the stem tube 82a and the piston small diameter portion 122a. The third biasing member 124 biases the accumulator piston 122 downward (toward a seating portion 63b).

The discharge head 112 does not have the accumulator valve 28 and the second biasing member 29, and is fitted onto the upper end portion of the stem tube 82a, which is located above the upper support tube 82b. The discharge hole 12c is in communication with the inside of the stem tube 82a.

When the discharge head 112 is pressed down, the stem 82, the accumulator valve body 123, and the accumulator piston 122 descend together with the discharge head 112. Here, the stem 82, the accumulator valve body 123, and the accumulator piston 122 descend relative to the accumulator cylinder 121 by the gap in the upward/downward direction between the lower edge of the piston large diameter portion 122b and the locking protrusion 121a of the accumulator cylinder 121. In this way, the accumulator piston 122, which has a smaller diameter than the piston part 22, descends (operates) before the piston part 22 (i.e., ahead of the piston part 22). For this reason, it is possible to reduce an initial pressing-down force when the discharge head 112 is lowered.

After the lower edge of the piston large diameter portion 122b comes into contact with the locking protrusion 121a of the accumulator cylinder 121, the piston part 22 also descends. Accordingly, the sliding portion 22a of the piston part 22 slides on the inner circumferential surface of the cylinder part 21, and thus, the inside of the cylinder part 21 is pressurized. When the piston part 22 reaches a falling end position where further downward movement is restricted, the stem 82 and the accumulator valve body 123 descend relative to the accumulator piston 122 against the biasing force of the third biasing member 124. Accordingly, the seating portion 123b is separated downward from the lower edge of the piston small diameter portion 122a. Then, the content liquid in the cylinder part 21 flows into the stem tube 82a through the inside of the accumulator cylinder 121, the gap between the accumulator piston 122 and the accumulator valve body 123, and the communication groove 82d. After that, the content liquid passes through the upper end opening of the stem tube 82a, and is discharged forward through the discharge hole 12c.

When the pressing-down of the discharge head 112 is released, the stem 82 and the accumulator valve body 123 are pushed up by the biasing force of the third biasing member 124, and the seating portion 123b abuts against the lower edge of the piston small diameter portion 122a. Accordingly, communication between the inside of the cylinder part 21 and the inside of the stem tube 82a is cut off, and the stem 82 is pushed up by the biasing force of the first biasing member 23, causing the stem 82, the accumulator valve body 123, the accumulator piston 122, the accumulator cylinder 121, and the piston part 22 to rise relative to the cylinder part 21. Then, the pressure inside the cylinder part 21 becomes negative. Accordingly, like the first embodiment, the content liquid is supplied into the cylinder part 21 from the content liquid inlet 21f.

The unit 2 for upright and inverted attitudes includes a first switching valve 61, a second switching valve 62, an outer tube member 63, an inner tube member 64, a channel forming member 65, a first connecting member 83, and a second connecting member 84.

The outer tube member 63 is constituted by, from top to bottom, the first outer tube portion 71, a fifth outer tube portion 163, and the fourth outer tube portion 74, lined up in this order. The relay port 64c of the inner tube member 64 is open in the fifth outer tube portion 163. A lower end opening of the fifth outer tube portion 163 becomes the upright-attitude inlet 63a that is open in the upward/downward direction. A third connecting tube portion 163a protruding upward is formed in an opening circumferential edge portion of the upright-attitude inlet 63a in the inner surface of the fifth outer tube portion 163.

A plug 165b and a common channel 68 are formed in a bottom wall portion of the channel forming member 65. The plug 165b is located radially inward from the seal tube portion 65c. The plug 165b does not protrude upward from the bottom wall portion of the channel forming member 65, but protrudes downward.

The first connecting member 83 is formed in a tubular shape extending in the upward/downward direction and connects the channel forming member 65 and the inner tube member 64 in the upward/downward direction. The plug 165b of the channel forming member 65 is closely fitted into the upper end portion of the first connecting member 83. The upper end portion of the first connecting member 83 is inserted into the seal tube portion 65c. The first connecting member 83 is disposed across the inside of the lower tip portion of the first outer tube portion 71 and the inside of the upper portion of the fifth outer tube portion 163. An annular gap extending in the circumferential direction is provided each between an outer circumferential surface of the upper end portion of the first connecting member 83 and an inner circumferential surface of the seal tube portion 65c and between an outer circumferential surface of a portion of the first connecting member 83 located below the upper end portion and an inner circumferential surface of the fifth outer tube portion 163. The upper end opening edge of the first connecting member 83 is separated downward from the lower surface of the bottom wall portion of the channel forming member 65, and the gap on the side of the outer circumferential surface of the first connecting member 83 is in communication with the common channel 68. The upper end portion of the first inner tube portion 76 of the inner tube member 64 is closely fitted into the lower tip portion of the first connecting member 83.

The second connecting member 84 is formed in a tubular shape extending in the upward/downward direction, and connects the inner tube member 64 and the third connecting tube portion 163a of the outer tube member 63 in the upward/downward direction. The lower tip portion of the third inner tube portion 78 of the inner tube member 64 is closely fitted into the upper end portion of the second connecting member 84. The third connecting tube portion 163a of the outer tube member 63 is closely fitted into the lower tip portion of the second connecting member 84.

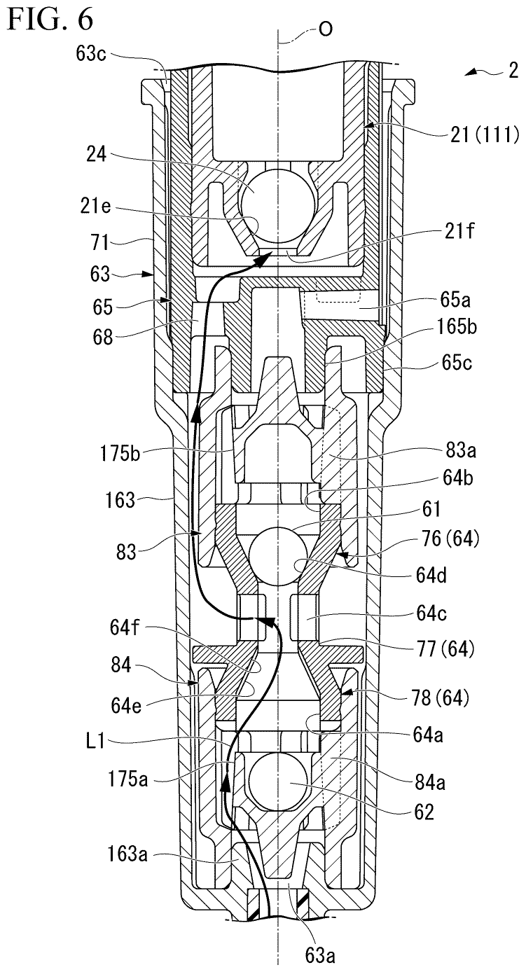

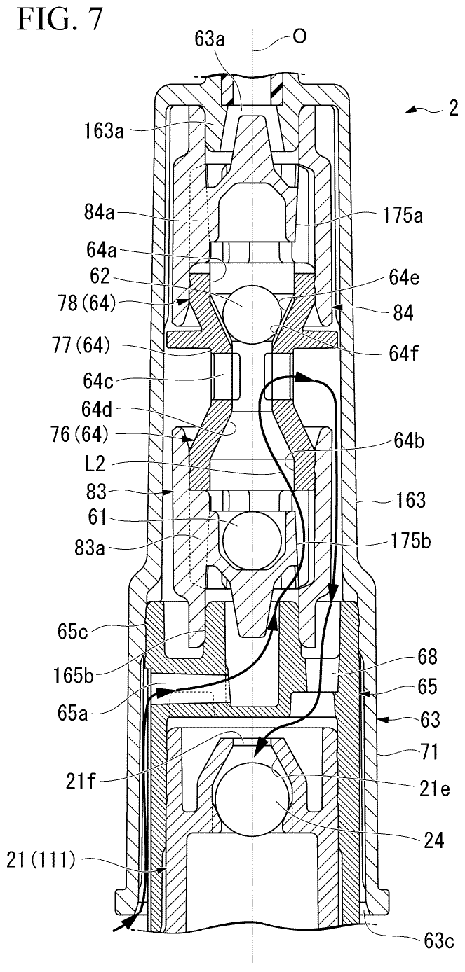

Then, in the embodiment, there are provided both a prevention part 175a (first prevention part) configured to prevent the second switching valve 62 from entering the first path L1 through which the content liquid is directed toward the relay port 64c from the upright-attitude inlet 63a during the upright attitude of the discharge device 110 as shown in FIG. 6 and a prevention part 175b (second prevention part) configured to prevent the first switching valve 61 from entering the second path L2 through which the content liquid is directed toward the relay port 64c from the inverted-attitude inlet 65a during the inverted attitude of the discharge device 110 as shown in FIG. 7.

Further, only one of the prevention part 175a and the prevention part 175b may be provided.

Each of the prevention part 175a (first prevention part) and the prevention part 175b (second prevention part) is formed in a tubular shape extending in the upward/downward direction and disposed coaxially with the axis O. The prevention part 175a and the prevention part 175b each extend continuously around the entire circumference. Further, the prevention part 175a and the prevention part 175b may each extend intermittently in the circumferential direction or may be C-shaped when seen in the upward/downward direction.

The prevention part 175a (first prevention part) is provided at a position where the inside faces the inverted-attitude valve seat 64e in the upward/downward direction and the second switching valve 62 enters the inside and is accommodated therein during the upright attitude of the discharge device 110. The prevention part 175a is formed in a bottomed tubular shape. The upper surface of the bottom wall of the prevention part 175a supports the second switching valve 62 entering the prevention part 175a and accommodated therein during the upright attitude of the discharge device 110. An outer circumferential edge portion of the upper surface of the bottom wall of the prevention part 175a extends downward as it goes inward in the radial direction. Further, the inner circumferential surface of the circumferential wall of the prevention part 175a may support the second switching valve 62 during the upright attitude of the discharge device 110. A size of the inside of the prevention part 175a in the upward/downward direction is equal to the diameter of the second switching valve 62.

The prevention part 175b (second prevention part) is provided at a position where the inside faces the upright-attitude valve seat 64d in the upward/downward direction and the first switching valve 61 enters the inside and is accommodated therein during the inverted attitude of the discharge device 110. The prevention part 175b is formed in a topped tubular shape. The lower surface of the top wall of the prevention part 175b supports the first switching valve 61 entering the inside of the prevention part 175b and accommodated therein during the inverted attitude of the discharge device 110. The outer circumferential edge portion of the lower surface of the top wall of the prevention part 175b extends upward as it goes inward in the radial direction. Further, the inner circumferential surface of the circumferential wall of the prevention part 175b may support the first switching valve 61 during the inverted attitude of the discharge device 110. A size of the inside of the prevention part 175b in the upward/downward direction is equal to the diameter of the first switching valve 61.

The prevention part 175a (first prevention part) is provided inside the second connecting member 84. The outer circumferential surface of the prevention part 175a and the inner circumferential surface of the second connecting member 84 are connected via first connecting pieces 84a provided at intervals in the circumferential direction. The prevention part 175a is located below the upper end portion of the second connecting member 84. A gap in the radial direction between the outer circumferential surface of the prevention part 175a and the inner circumferential surface of the second connecting member 84 constitutes a part of the first path L1.

The prevention part 175b (second prevention part) is provided inside the first connecting member 83. The outer circumferential surface of the prevention part 175b and the inner circumferential surface of the first connecting member 83 are connected via second connecting pieces 83a provided at intervals in the circumferential direction. The prevention part 175b is located above the lower tip portion of the first connecting member 83. A gap in the radial direction between the outer circumferential surface of the prevention part 175b and the inner circumferential surface of the first connecting member 83 constitutes a part of the second path L2.

The prevention part 175a (first prevention part), the second connecting member 84, and the first connecting piece 84a constitute one part that is formed integrally. The prevention part 175b (second prevention part), the first connecting member 83, and the second connecting piece 83a also constitute one part that is formed integrally. The parts of the former and the parts of the latter are common parts formed in the same shape with the same size and assembled upside down.

As described above, according to the unit 2 for upright and inverted attitudes of the embodiment, at least one switching valve of the first switching valve 61 and the second switching valve 62 enters the inside of the prevention part 175b (second prevention part) or 175a (first prevention part) and is accommodated therein when the switching valve is separated from the valve seat 64d or 64e in the upward/downward direction. Accordingly, when the content liquid in the container main body W is introduced into the content liquid inlet 21f of the cylinder part 21, it is possible to reliably do at least one of the preventing the content liquid flowing through the first path L1 from coming into contact with the second switching valve 62, the second switching valve 62 from riding the liquid flow of the content liquid and approaching the inverted-attitude valve seat 64e, during the upright attitude of the discharge device 110, and the preventing the content liquid flowing through the second path L2 from coming into contact with the first switching valve 61, the first switching valve 61 from riding the liquid flow of the content liquid and approaching the upright-attitude valve seat 64d, during the inverted attitude of the discharge device 110.

The prevention parts 175b (second prevention part) and 175a (first prevention part) are provided at a position facing the upright-attitude valve seat 64d in the upward/downward direction and where the first switching valve 61 enters the inside and is accommodated therein during the inverted attitude of the discharge device 110 and a position facing the inverted-attitude valve seat 64e in the upward/downward direction and where the second switching valve 62 enters the inside and is accommodated therein during the upright attitude of the discharge device 110. Accordingly, when the content liquid in the container main body W is introduced into the content liquid inlet 21f of the cylinder part 21, it is possible to reliably prevent both the content liquid flowing through the first path L1 from coming into contact with the second switching valve 62 and the second switching valve 62 from riding the liquid flow of the content liquid and approaching the inverted-attitude valve seat 64e during the upright attitude of the discharge device 110, and the content liquid flowing through the second path L2 from coming into contact with the first switching valve 61 and the first switching valve 61 from riding the liquid flow of the content liquid and approaching the upright-attitude valve seat 64d during the inverted attitude of the discharge device 110.

Since the prevention parts 175b and 175a are provided at both of the above-mentioned positions, the two parts provided at each of the above-mentioned positions and having the prevention parts 175b and 175a can easily be made to be of the same shape and size.

Further, the technical scope of the present invention is not limited to the above-mentioned embodiment, and various modifications can be made without departing from the spirit of the present invention.

The covering portion 51 and the guide portion 52 may not be provided inside the outer tube member 63.

The escape recess 69 (second escape recess and second prevention part) for the first switching valve 61 and the escape recess 90 (first escape recess) for the second switching valve 62 may not be provided.

The covering portion 51 may be formed in a topped tubular shape extending around the entire circumference and arranged coaxially with the axis O, the side opening 51a may be formed with a plurality of parts at intervals in the circumferential direction on the circumferential wall of the covering portion 51, and the prevention part 75 (first prevention part) for the second switching valve 62 may be formed in a tubular shape extending continuously around the entire circumference and arranged coaxially with the axis O on the outer circumferential edge portion of the top wall of the covering portion 51. In this configuration, the second switching valve 62 is located on the upper surface of the top wall of the covering portion 51 inside the prevention part 75 and arranged on the axis O.

In this case, this makes it easier to position the second switching valve 62 in close contact with the inverted-attitude valve seat 64e during the inverted attitude of the discharge device 10.

### INDUSTRIAL APPLICABILITY

According to the present invention, it is possible to smoothly introduce the content liquid in the container main body into the cylinder part.

In addition, the components in the embodiments may be replaced with well-known components as appropriate, and the above-described embodiments and modified examples may be combined as appropriate without departing from the spirit of the present invention.

### REFERENCE SIGNS LIST

1, 2 Unit for upright and inverted attitudes
10, 110 Discharge device
11, 111 Pump
12, 112 Discharge head
12c Discharge hole
21 Cylinder part
21f Content liquid inlet
51 Covering portion
51a Side opening
52 Guide portion
61 First switching valve
62 Second switching valve
63 Outer tube member
63a Upright-attitude inlet
64c Relay port
64d Upright-attitude valve seat
64e Inverted-attitude valve seat
65 Channel forming member
5a Inverted-attitude inlet
65b Plug (topped tubular portion)
68 Common channel
69 Escape recess (second escape recess, second prevention part)
75 Prevention part (first prevention part)
90 Escape recess (first escape recess)
175a Prevention part (first prevention part)
175b Prevention part (second prevention part)
L1 First path
L2 Second path
W Container main body
W1 Mouth portion

1. A unit for upright and inverted attitudes attached to a cylinder part of a discharge device, the unit for upright and inverted attitudes comprising:
an upright-attitude inlet into which a content liquid in a container main body is able to be introduced into a content liquid inlet of the cylinder part during an upright attitude of the discharge device;
an inverted-attitude inlet into which the content liquid in the container main body is able to be introduced into the content liquid inlet during an inverted attitude of the discharge device;
a relay port that is able to communicate with the content liquid inlet, the upright-attitude inlet, and the inverted-attitude inlet;
a first switching valve abutting an upright-attitude valve seat and configured to cut off communication between the inverted-attitude inlet and the relay port during the upright attitude of the discharge device;
a second switching valve abutting an inverted-attitude valve seat and configured to cut off communication between the upright-attitude inlet and the relay port during the inverted attitude of the discharge device; and
at least one prevention part of a first prevention part and a second prevention part,
the first prevention part being configured to prevent the second switching valve from entering a first path through which the content liquid is directed toward the relay port from the upright-attitude inlet during the upright attitude of the discharge device, and
the second prevention part being configured to prevent the first switching valve from entering a second path through which the content liquid is directed toward the relay port from the inverted-attitude inlet during the inverted attitude of the discharge device.

2. The unit for upright and inverted attitudes according to claim 1, further comprising:
an outer tube member fitted onto the cylinder part and having a lower end opening that becomes the upright-attitude inlet,
wherein a topped tubular covering portion protruding upward and configured to cover the upright-attitude inlet from above is formed on an opening circumferential edge portion of the upright-attitude inlet in an inner surface of the outer tube member,
a side opening that opens in a radial direction and configured to communicate with the upright-attitude inlet and an inside of the outer tube member is formed in a circumferential wall of the covering portion, and
the first prevention part configured to prevent the second switching valve from entering the first path during the upright attitude of the discharge device protrudes upward from a top wall of the covering portion.

3. The unit for upright and inverted attitudes according to claim 2, wherein
the first prevention part is formed in a plate shape with a front surface that opens on a side in a radial direction where the side opening is open when seen in an upward/downward direction,
a space between a portion of an inner circumferential surface of the outer tube member facing the side opening and a front surface of the first prevention part in the radial direction and the side opening and the front surface of the first prevention part becomes an inlet portion of the first path, and
a guide portion configured to guide the second switching valve attempting to enter the inlet portion toward a back surface of the first prevention part during the upright attitude of the discharge device is provided inside the outer tube member.

4. The unit for upright and inverted attitudes according to claim 1, further comprising:
at least one escape recess of a first escape recess and a second escape recess,
the first escape recess being configured to allow the second switching valve to enter therein and separate the second switching valve from the first path on a side opposite to the inverted-attitude valve seat and in a direction crossing an opening direction of the upright-attitude inlet during the upright attitude of the discharge device, and
the second escape recess being configured to allow the first switching valve to enter therein and separate the first switching valve from the second path on a side opposite to the upright-attitude valve seat and in a direction crossing an opening direction of the inverted-attitude inlet during the inverted attitude of the discharge device.

5. The unit for upright and inverted attitudes according to claim 1, wherein
the upright-attitude valve seat is directed upward,
the inverted-attitude valve seat is directed downward,
the at least one prevention part is formed in a tubular shape extending in the upward/downward direction and faces at least one valve seat of the upright-attitude valve seat and the inverted-attitude valve seat in the upward/downward direction, and
at least one switching valve of the first switching valve and the second switching valve enters an inside of the at least one prevention part and is accommodated therein when the at least one switching valve is separated from the at least one valve seat in the upward/downward direction.

6. The unit for upright and inverted attitudes according to claim 5, wherein
the at least one prevention part is the second prevention part and the first prevention part,
the second prevention part is provided at a position facing the upright-attitude valve seat in the upward/downward direction and where the first switching valve enters thereinto and is accommodated therein during the inverted attitude of the discharge device, and
the first prevention part is provided at a position facing the inverted-attitude valve seat in the upward/downward direction and where the second switching valve enters thereinto and is accommodated therein during the upright attitude of the discharge device.

7. The unit for upright and inverted attitudes according to claim 2, further comprising:
at least one escape recess of a first escape recess and a second escape recess,
the first escape recess being configured to allow the second switching valve to enter therein and separate the second switching valve from the first path on a side opposite to the inverted-attitude valve seat and in a direction crossing an opening direction of the upright-attitude inlet during the upright attitude of the discharge device, and
the second escape recess being configured to allow the first switching valve to enter therein and separate the first switching valve from the second path on a side opposite to the upright-attitude valve seat and in a direction crossing an opening direction of the inverted-attitude inlet during the inverted attitude of the discharge device. (New) The unit for upright and inverted attitudes according to claim 3, further comprising:
at least one escape recess of a first escape recess and a second escape recess,
the first escape recess being configured to allow the second switching valve to enter therein and separate the second switching valve from the first path on a side opposite to the inverted-attitude valve seat and in a direction crossing an opening direction of the upright-attitude inlet during the upright attitude of the discharge device, and
the second escape recess being configured to allow the first switching valve to enter therein and separate the first switching valve from the second path on a side opposite to the upright-attitude valve seat and in a direction crossing an opening direction of the inverted-attitude inlet during the inverted attitude of the discharge device.
